(19) United States
(12) Patent Application Publication
(10) Pub. No.: US 2025/0321437 A1
(43) Pub. Date: Oct. 16, 2025

(54) ORTHOKERATOLOGY LENSES AND MANUFACTURING METHOD THEREOF

(71) Applicant: Shanghai FULO Medical Instrument Co., Ltd., Shanghai (CN)

(72) Inventors: Baoguang JIANG, Shanghai (CN); Mototora KAI, Shanghai (CN); An LI, Shanghai (CN)

(73) Assignee: Shanghai FULO Medical Instrument Co., Ltd., Shanghai (CN)

(21) Appl. No.: 18/811,429

(22) Filed: Aug. 21, 2024

(30) Foreign Application Priority Data
Apr. 10, 2024 (CN) 202410430982.1

(51) Int. Cl. G02C 7/04; G02C 7/02

(52) U.S. Cl. CPC G02C 7/047; G02C 7/025

(57) ABSTRACT

The present disclosure provides orthokeratology lenses and a manufacturing method thereof. The manufacturing method includes: acquiring parameters of diseased eyes; constructing a cornea model based on the parameters of the diseased eyes, and obtaining control point data of an orthokeratology lenses model according to the parameters of the diseased eyes and the cornea model; constructing the orthokeratology lenses model adaptively on a surface of the cornea model based on the control point data; and manufacturing orthokeratology lenses for the diseased eyes in accordance with the orthokeratology lenses model. By freely adjusting control points and changing a spline surface parameter, more customization requirements can be met.

### CROSS-REFERENCE TO RELATED APPLICATIONS

This application claims priority to Chinese Patent Application No. 202410430982.1 with a filing date of Apr. 10, 2024. The content of the aforementioned application, including any intervening amendments thereto, is incorporated herein by reference.

### TECHNICAL FIELD

The present disclosure relates to the field of orthokeratology lenses design, and in particular, to orthokeratology lenses and a manufacturing method thereof.

### BACKGROUND

Orthokeratology lenses are rigid gas permeable contact lenses for treating refractive errors of the cornea. The center of the lenses is flatter than the center of the cornea. Under the compression action of the eyelid, the center of the lenses exerts a positive pressure on the center of the cornea, forcing the epithelial cells of the center of the cornea to migrate around. Thus, the center of the cornea is flattened and a degree of myopia of the naked eye is reduced. A relatively enclosed cavity is remained between the periphery of the center of the lenses and the cornea to provide an enough accommodating space for tear fluid and the epithelial cells migrating from the center of the cornea. Under the action of the tear fluid, there is a certain negative pressure in the cavity, forcing the epithelial cells migrating from the center of the cornea to be accumulated in the cavity and thus forming a myopic defocusing ring. The formation of the myopic defocusing ring helps slow down the growth of the eye axis and reduce the increasing speed of the degree of myopia of the naked eye.

The basic principle of traditional orthokeratology lenses is to adopt a reverse geometry design manner. The traditional orthokeratology lenses include four curve zones, namely a base curve zone, a reverse curve zone, an adaptation curve zone, and a peripheral curve zone from the center to the edge of the lens. The base curve zone is of a structure like a cambered surface. The adaptation curve zone is of a slightly wide annular structure. Both of the reverse curve zone and the peripheral curve zone are of a slightly narrow annular structure. The base curve zone, as a central optical zone and a treatment region, is used to flatten the central region of the cornea. The adaptation curve zone, as a locating zone, is in close fit with the surface of the cornea, and plays a role in fixing the lens, ensuring the stability of lenses wearing. The reverse curve zone, as a transition region of the base curve zone and the adaptation curve zone, forms a cavity with the surface of the cornea and plays a role in gathering the tear fluid. The peripheral curve zone slightly warps the edge of the lenses to ensure smooth exchange between the tear fluids on inner and outer sides of the lenses and provide good oxygen permeability.

In an existing design method of orthokeratology lenses, the base curve zone, the adaptation curve zone, and the peripheral curve zone are still designed by the traditional method, and the problem of low degree of freedom in adjustment of each curve zone in the traditional design is not thoroughly solved. Therefore, an entrance pupil defocusing amount of the base curve zone, an adaptation degree of the adaptation curve zone, and an edge warping height of the peripheral curve zone cannot be adjusted freely.

### SUMMARY OF PRESENT INVENTION

An objective of the present disclosure is to provide orthokeratology lenses and a manufacturing method thereof, which can overcome the limitations of the traditional design method. An entrance pupil defocusing amount of a base curve zone, a peripheral defocusing amount of a reverse curve zone, an adaptation degree of an adaptation curve zone, and an edge warping height of a peripheral curve zone can be more flexibly adjusted.

To achieve the above objective, the present disclosure provides the following technical solutions:

A manufacturing method of orthokeratology lenses includes the following steps:
acquiring parameters of diseased eyes;
constructing a cornea model based on the parameters of the diseased eyes, and obtaining control point data of an orthokeratology lenses model according to the parameters of the diseased eyes and the cornea model;
constructing the orthokeratology lenses model adaptively on a surface of the cornea model based on the control point data; and
manufacturing orthokeratology lenses for the diseased eyes in accordance with the orthokeratology lenses model.

In a preferred embodiment, the parameters of the diseased eyes include elevation data of the anterior corneal surface; and the constructing a cornea model based on the parameters of the diseased eyes includes:
fitting the elevation data of the anterior corneal surface to obtain the cornea model.

In a preferred embodiment, the obtaining the control point data of the orthokeratology lenses model according to the parameters of the diseased eyes and the cornea model includes:
obtaining dimensions data of curve zones of the orthokeratology lenses model according to the parameters of the diseased eyes, where the orthokeratology lenses model comprises a base curve zone, a reverse curve zone, an adaptation curve zone, and a peripheral curve zone; and
selecting control points of the curve zones of the orthokeratology lenses model, and obtaining the control point data of the orthokeratology lenses model according to the dimensions data of the curve zones of the orthokeratology lenses model.

In a preferred embodiment, the obtaining the dimensions data of the curve zones of the orthokeratology lenses model according to the parameters of the diseased eyes includes:
determining radial dimensions of the base curve zone, the reverse curve zone, the adaptation curve zone, and the peripheral curve zone according to the parameters of the diseased eyes; and
selecting an entrance pupil defocusing amount of the base curve zone, a peripheral defocusing amount of the reverse curve zone, an adaptation degree of the adaptation curve zone, and an edge warping height of the peripheral curve zone.

In a preferred embodiment, the parameters of the diseased eyes include a horizontal iris diameter; and the determining the radial dimensions of the base curve zone, the reverse curve zone, the adaptation curve zone, and the peripheral curve zone according to the parameters of the diseased eyes includes:
calculating a diameter of the orthokeratology lenses model according to the horizontal iris diameter; and
determining the radial dimensions of the base curve zone, the reverse curve zone, the adaptation curve zone, and the peripheral curve zone based on the diameter of the orthokeratology lenses model.

In a preferred embodiment, the selecting control points of the curve zones of the orthokeratology lenses model includes:
selecting a center of the base curve zone, a midpoint of a radial width of the reverse curve zone, a midpoint of a radial width of the adaptation curve zone, any point in an outer edge of the base curve zone, any point in an outer edge of the reverse curve zone, any point in an outer edge of the adaptation curve zone, and any point in an outer edge of the peripheral curve zone as the control points.

In a preferred embodiment, the control point data includes a radial distance and a longitudinal distance; and the obtaining the control point data of the orthokeratology lenses model according to the dimensions data of the curve zones of the orthokeratology lenses model includes:
obtaining radial distances of the control points of the curve zones according to the radial dimensions of the base curve zone, the reverse curve zone, the adaptation curve zone, and the peripheral curve zone; and
calculating longitudinal distances of the control points of the curve zones based on the entrance pupil defocusing amount of the base curve zone, the peripheral defocusing amount of the reverse curve zone, the adaptation degree of the adaptation curve zone, and the edge warping height of the peripheral curve zone.

In a preferred embodiment, the constructing the orthokeratology lenses model adaptively on the surface of the cornea model based on the control point data includes:
setting control points on the surface of the cornea model according to the control point data; and
modeling the curve zones with the control points to obtain the orthokeratology lenses model.

The present disclosure further provides orthokeratology lenses, having a base curve zone, a reverse curve zone, an adaptation curve zone, and a peripheral curve zone successively from a center outward,
where a center of the base curve zone, a midpoint of a radial width of the reverse curve zone, a midpoint of a radial width of the adaptation curve zone, any point in an outer edge of the base curve zone, any point in an outer edge of the reverse curve zone, any point in an outer edge of the adaptation curve zone, and any point in an outer edge of the peripheral curve zone are set as control points.

Compared with the prior art, the technical solutions provided have the following advantages.

The cornea model is established according to the elevation data of the anterior corneal surface acquired by a corneal topographer. On this basis, the orthokeratology lenses model is integrally formed based on a spline surface. By freely adjusting the control points and changing a spline surface parameter, more customization requirements can be met.

The control point is set in the base curve zone such that the functional region of the base curve zone is refined, and the control point is adjusted to provide a controllable entrance pupil defocusing amount for the human eye. The control point is set in the reverse curve zone, and is adjusted to provide a fixed peripheral defocusing amount for corneas having different biological characteristics. The control point is set in the adaptation curve zone, and is adjusted to provide comfortable adaptation degrees for corneas different in morphology. The control point is set in the peripheral curve zone, and is adjusted to design different edge warping heights and provide good oxygen permeability for corneas different in tear film mass.

The orthokeratology lenses manufactured in the present disclosure is conducive to vision correction and stabilization and to effectively delaying vision progress, and is gas permeable and comfortable to wear.

The following describes the present disclosure with reference to accompanying drawings and embodiments.

### BRIEF DESCRIPTION OF THE DRAWINGS

FIG. 1 shows a manufacturing method of orthokeratology lenses according to the present disclosure;

FIG. 2 is a schematic flowchart showing step S2 in the manufacturing method of orthokeratology lenses according to the present disclosure;

FIG. 3 is a schematic flowchart showing step S22 in the manufacturing method of orthokeratology lenses according to the present disclosure;

FIG. 4 is a schematic flowchart showing step S23 in the manufacturing method of orthokeratology lenses according to the present disclosure;

FIG. 5 is a structural schematic diagram of an orthokeratology lenses model according to the present disclosure; and

FIG. 6 is a schematic diagram of establishing an orthokeratology lenses model on the basis of the cornea model.

### LIST OF REFERENCE NUMERALS

1-base curve zone, 11-central optical zone, 12-near sighting defocusing zone, 2-reverse curve zone, 3-adaptation curve zone, 4-peripheral curve zone, 5-orthokeratology lenses model, 6-cornea model, 71-control point at a center of the central optical zone, 72-control point in an edge of the central optical zone, 73-control point at a midpoint of a radial width of the near sighting defocusing zone, 74-control point in an outer edge of the near sighting defocusing zone, 75-control point at a midpoint of a radial width of the reverse curve zone, 76-control point in an outer edge of the reverse curve zone, 77-control point at a midpoint of a radial width of the adaptation curve zone, 78-control point in an outer edge of the adaptation curve zone, and 79-control point in an outer edge of the peripheral curve zone.

### DETAILED DESCRIPTION OF THE EMBODIMENTS

The following description is used to illustrate the present disclosure such that those skilled in the art can implement the present disclosure. Preferred embodiments in the following description are merely examples, and other apparent variations are conceivable to those skilled in the art. The basic principles of the present disclosure defined in the following description may be applied to other embodiments, variations, improvements, equivalents, and other technical solutions that do not depart from the spirit and scope of the present disclosure.

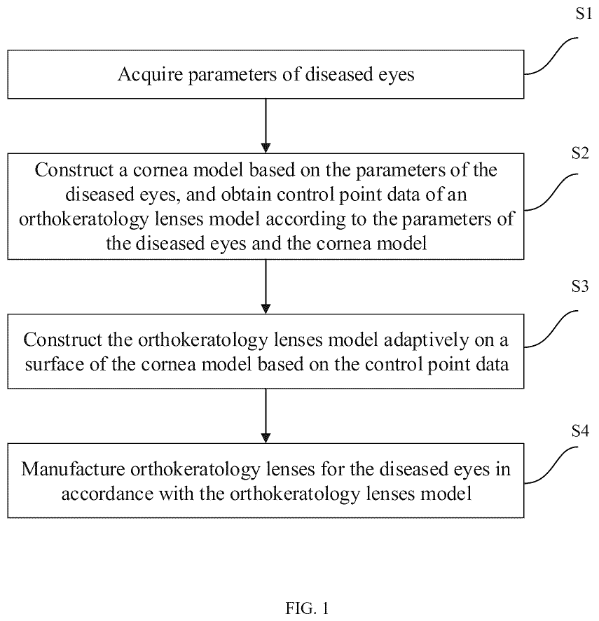

FIG. 1 is a schematic diagram of a manufacturing method of orthokeratology lenses provided by an embodiment of the present disclosure. The manufacturing method includes the following steps.

In step S1, parameters of diseased eyes are acquired.

In step S2, a cornea model 6 is constructed based on the parameters of the diseased eyes, and control point data of an orthokeratology lenses model 5 is obtained according to the parameters of the diseased eyes and the cornea model 6.

In step S3, the orthokeratology lenses model 5 is constructed adaptively on a surface of the cornea model 6 based on the control point data.

In step S4, orthokeratology lenses for the diseased eye are manufactured in accordance with the orthokeratology lenses model 5.

Control points for constructing the orthokeratology lenses model are set on the cornea model 6 to obtain the orthokeratology lenses model 5. Each control point has a radial distance and a longitudinal distance, such as an entrance pupil defocusing amount of a base curve zone and an edge warping height of a peripheral curve zone. Therefore, the flexibility of increasing the entrance pupil defocusing amount of the base curve zone and the edge warping height of the peripheral curve zone can be improved by adjusting the control points. The limitations of a traditional design method can be broken through.

Specifically, the manufacturing method of orthokeratology lenses provided by an embodiment of the present disclosure includes the following steps.

In step S1, parameters of diseased eyes are acquired.

The diseased eyes refer to the eyes in need of wearing orthokeratology lenses. The parameters of the diseased eyes include elevation data of the anterior corneal surface and a horizontal iris diameter of the diseased eye, and etc. Herein, the purpose of acquiring the parameters of the diseased eyes is to construct a cornea model and an orthokeratology lenses model corresponding to the diseased eye.

In step S2, a cornea model 6 is constructed based on the parameters of the diseased eyes, and control point data of an orthokeratology lenses model 5 is obtained according to the parameters of the diseased eyes and the cornea model 6.

The cornea model 6 is a digital description of a corneal morphology, and is constructed and represented by a mathematical algorithm and a computer technique based on particular parameters and features of the cornea of the diseased eye. Such a model helps understand the physiological structure, optical characteristics, and lesion of the cornea more deeply, and provides strong support for the design of orthokeratology lenses.

Here, the purpose of constructing the cornea model 6 and obtaining the control point data of the orthokeratology lenses model 5 is to obtain the orthokeratology lenses model 5.

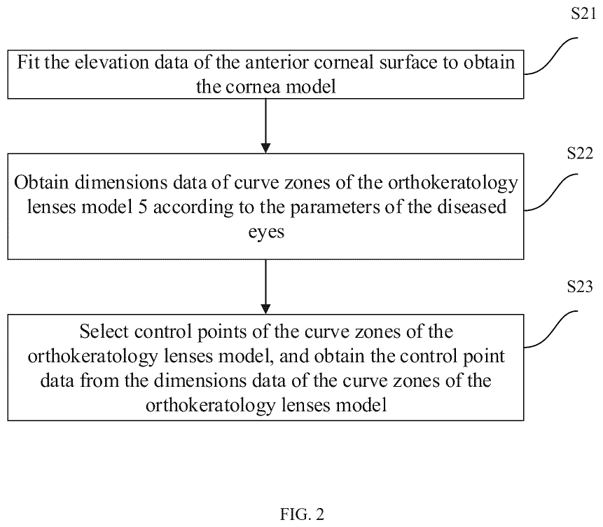

With reference to FIG. 2, the parameters of the diseased eyes include elevation data of the anterior corneal surface; and the constructing the cornea model 6 based on the parameters of the diseased eyes includes the following steps.

In step S21, the elevation data of the anterior corneal surface is fitted to obtain the cornea model 6.

The elevation data of the anterior corneal surface is data composed of longitudinal vector height differences of a series of points on the anterior corneal surface from the corneal vertex.

Specifically, the elevation data of the anterior corneal surface is obtained based on a corneal topographer, and then the cornea model 6 is established according to the elevation data of the anterior corneal surface.

The corneal topographer may be employed to measure the elevation data of the anterior corneal surface of the diseased eyes of a wearer before the orthokeratology, thereby obtaining the elevation data of the anterior corneal surface. The elevation data of the anterior corneal surface is then fitted by zernike polynomials to obtain a fitted surface as the cornea model.

With reference to FIG. 2 to FIG. 6, the obtaining the control point data of the orthokeratology lenses model 5 according to the parameters of the diseased eyes and the cornea model 6 includes the following steps.

In step S22, dimensions data of curve zones of the orthokeratology lenses model 5 is obtained according to the parameters of the diseased eyes. The orthokeratology lenses model 5 comprises a base curve zone 1, a reverse curve zone 2, an adaptation curve zone 3, and a peripheral curve zone 4.

In step S23, control points of the curve zones of the orthokeratology lenses model 5 are selected, and the control point data is obtained from the dimensions data of the curve zones of the orthokeratology lenses model 5.

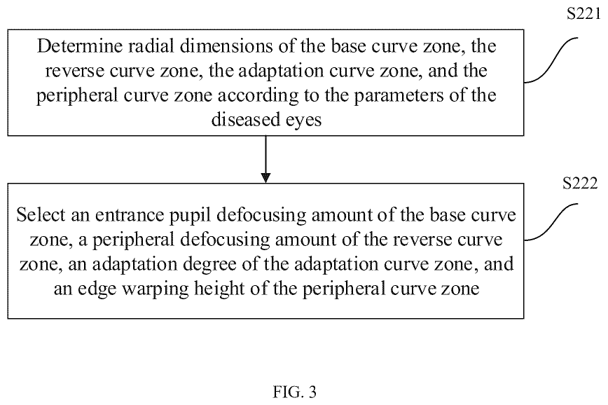

In step S22, the obtaining the dimensions data of the curve zones of the orthokeratology lenses model 5 according to the parameters of the diseased eyes includes the following steps, as shown in FIG. 3.

In step S221, radial dimensions of the base curve zone 1, the reverse curve zone 2, the adaptation curve zone 3, and the peripheral curve zone 4 are determined according to the parameters of the diseased eyes.

In step S222, an entrance pupil defocusing amount of the base curve zone 1, a peripheral defocusing amount of the reverse curve zone 2, an adaptation degree of the adaptation curve zone 3, and an edge warping height of the peripheral curve zone 4 are selected.

In step S221, the parameters of the diseased eyes include a horizontal iris diameter; and the determining the radial dimensions of the base curve zone 1, the reverse curve zone 2, the adaptation curve zone 3, and the peripheral curve zone 4 according to the parameters of the diseased eyes includes the following steps:
Calculating a diameter of the orthokeratology lenses model 5 according to the horizontal iris diameter; and
Determining the radial dimensions of the base curve zone 1, the reverse curve zone 2, the adaptation curve zone 3, and the peripheral curve zone 4 based on the diameter of the orthokeratology lenses model 5.

An iris measuring instrument is employed to measure the horizontal iris diameter d1 of the diseased eyes of the wearer before the orthokeratology. After the horizontal iris diameter d1 is obtained, the diameter d2 of the orthokeratology lenses is calculated according to d2=d1−1.

According to different customization requirements of the orthokeratology lens, the entrance pupil defocusing amount of the base curve zone 1, the peripheral defocusing amount of the reverse curve zone 2, the adaptation degree of the adaptation curve zone 3, and the edge warping height of the peripheral curve zone 4 are selected. The suitable entrance pupil defocusing amount of the base curve zone 1 and the suitable peripheral defocusing amount of the reverse curve zone 2 are selected to meet different requirements of different patients on vision progress control. The suitable adaptation degree of the adaptation curve zone 3 and the suitable edge warping height of the peripheral curve zone 4 are selected to guarantee that the lenses have a certain mobility and high oxygen permeability.

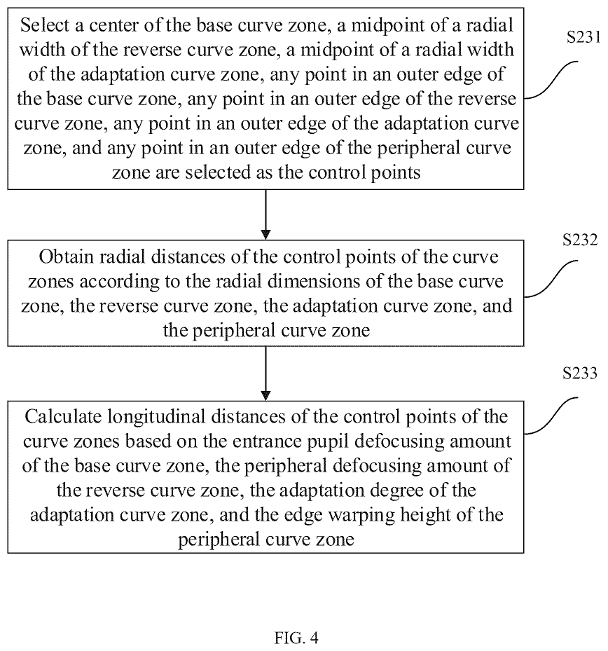

With reference to FIG. 2 and FIG. 4, the selecting the control points of the curve zones of the orthokeratology lenses model 5 includes the following steps.

In step S231, a center of the base curve zone 1, a midpoint of a radial width of the reverse curve zone 2, a midpoint of a radial width of the adaptation curve zone 3, any point in an outer edge of the base curve zone 1, any point in an outer edge of the reverse curve zone 2, any point in an outer edge of the adaptation curve zone 3, and any point in an outer edge of the peripheral curve zone 4 are selected as the control points.

The radial distance and the longitudinal distance of any point in the outer edge of the base curve zone 1 are equal, and therefore, any point in the outer edge of the base curve zone 1 may be selected as the control point.

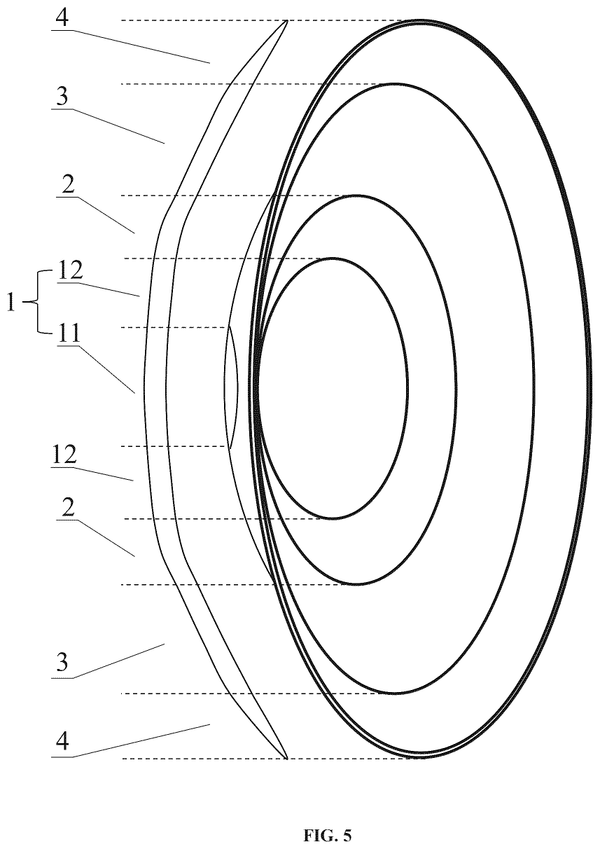

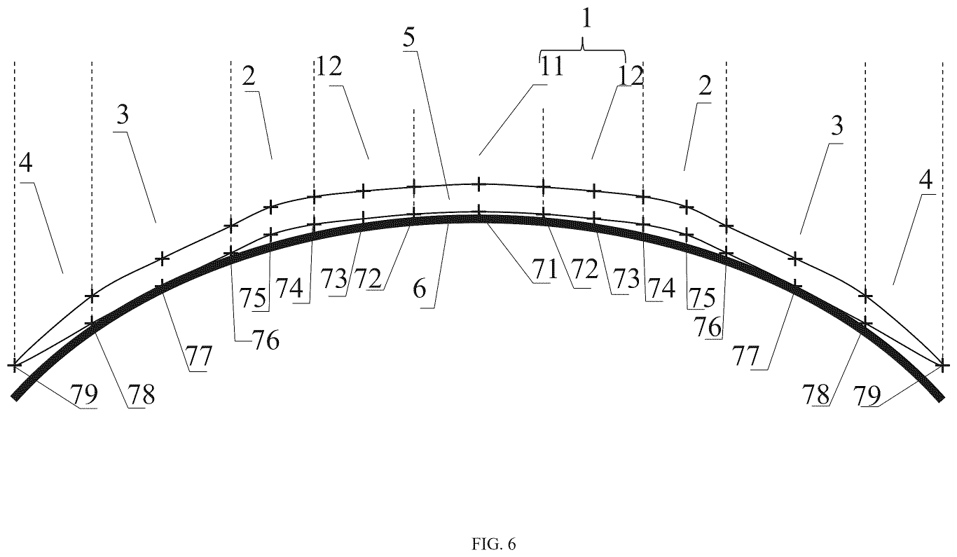

Further, with reference to FIG. 5 to FIG. 6, the base curve zone 1 includes a central optical zone 11 and a near sighting defocusing zone 12 disposed from inside to outside. Therefore, a center of the central optical zone 11, a midpoint of a radial width of the near sighting defocusing zone 12, the midpoint of the radial width of the reverse curve zone 2, the midpoint of the radial width of the adaptation curve zone 3, any point in an outer edge of the central optical zone 11, any point in an outer edge of the near sighting defocusing zone 12, any point in the outer edge of the reverse curve zone 2, any point in the outer edge of the adaptation curve zone 3, and any point in the outer edge of the peripheral curve zone 4 are selected as the control points.

With reference to FIG. 4 to FIG. 6, the control point data includes a radial distance and a longitudinal distance; and the obtaining the control point data of the orthokeratology lenses model 5 according to the dimensions data of the curve zones of the orthokeratology lenses model 5 includes the following steps.

In step S232, radial distances of the control points of the curve zones are obtained according to the radial dimensions of the base curve zone 1, the reverse curve zone 2, the adaptation curve zone 3, and the peripheral curve zone 4.

In step S233, longitudinal distances of the control points of the curve zones are calculated based on the entrance pupil defocusing amount of the base curve zone 1, the peripheral defocusing amount of the reverse curve zone 2, the adaptation degree of the adaptation curve zone 3, and the edge warping height of the peripheral curve zone 4.

The radial distance refers to a distance in a transverse direction in FIG. 6, and the longitudinal distance refers to a distance in a vertical direction in FIG. 6. The center of the central optical zone 11 is selected as the control point, and the radial distance and the longitudinal distance thereof are acquired by the following approach.

The radial distance of the control point at the center of the central optical zone 11 to the vertex of the cornea model 6 is 0. The longitudinal distance is equal to a reserved tear film elevation.

The control point at the center of the central optical zone 11 is disposed at a position with the radial distance of 0 to the vertex of the cornea model 6 and the longitudinal distance equal to the reserved tear film elevation.

For the control point selected as any point in the edge of the central optical zone 11, the radial distance and the longitudinal distance thereof are acquired by the following approach.

The radial distance of the selected control point of the central optical zone 11 to the vertex of the cornea model 6 is d3/2.

The longitudinal distance of the control point in the edge of the central optical zone 11 to the horizontal plane of the vertex of the cornea model 6 is determined with an axial curvature radius of the center of the central optical zone 11 and under a condition that a difference in axial diopter between the edge and the center of the central optical zone 11 is greater than or equal to 0 D and less than or equal to 0.5 D, where D is the unit of the diopter.

The following formula may be employed to calculate d3:

$$d 2 = d 3 + 2 \times ( w 1 + w 2 + w 3 + w 4 ) ;$$

where d2 represents the diameter of the orthokeratology lenses model, and d3 a diameter of the central optical zone, w1 the radial width of the near sighting defocusing zone, w2 the radial width of the reverse curve zone, w3 the radial width of the adaptation curve zone, w4 the radial width of the peripheral curve zone. Both the diameter and the radial width refer to radial distances.

Specifically, the axial curvature radius of the center of the central optical zone 11 is acquired to obtain the selected control point data of any point in the edge of the central optical zone 11.

With reference to FIG. 2, the axial curvature radius is a physical quantity for describing a degree of bending of a curve in a tangential direction thereof. The axial curvature radius of the center of the central optical zone may be calculated according to a diopter measured by an auto-refractor and a corneal curvature acquired by the corneal topographer.

The diopter is the data of a refractive power in ophthalmic optical check and is a form reflecting a refractive status of the eyeball. A corneal topography detector is also known as “corneal topographer”. The corneal topographer is an instrument for recoding and analyzing the corneal morphology using different methods by taking the surface of the cornea as a topography. The corneal curvature is a diopter or curvature radius value of the cornea. This indicator can be detected by a corneal curvature detecting instrument to determine the presence or absence of astigmatism and the nature of astigmatism, and is an item of refraction check.

Specifically, the auto-refractor and the corneal topographer are employed to measure the diopter and the corneal curvature c of the diseased eyes of the wear before the orthokeratology, respectively. The axial curvature radius of the center of the central optical zone is calculated by the following equation:

$$r 1 = 33 7.6 / ( 33 \; 7.6 \times c - t - f ) ;$$

where r1 represents the axial curvature radius of the center of the central optical zone, and c the corneal curvature, t a target reduced degree, and f a compensation value for the regression of the refractive power of the cornea after the lenses is removed. After the diopter is obtained, the diopter is calculated according to a correction principle to obtain the target reduced degree t.

For the control point selected as the midpoint of the radial width of the near sighting defocusing zone, the radial distance and the longitudinal distance thereof are acquired by the following approach.

The radial distance of the control point at the midpoint of the radial width of the near sighting defocusing zone to the vertex of the cornea model is d3/2+w1/2. The longitudinal distance of the control point at the midpoint of the radial width of the near sighting defocusing zone to the horizontal plane of the vertex of the cornea model is determined by the entrance pupil defocusing amount of the base curve zone 1.

For the control point selected as any point in the edge of the radial width of the near sighting defocusing zone, the radial distance and the longitudinal distance thereof are acquired by the following approach.

The radial distance of the control point in the edge of the radial width of the near sighting defocusing zone to the vertex of the cornea model is d3/2+w1. The longitudinal distance of the control point in the edge of the radial width of the near sighting defocusing zone to the horizontal plane of the vertex of the cornea model is determined by the entrance pupil defocusing amount of the base curve zone 1.

For the control point selected as the midpoint of the radial width of the reverse curve zone, the radial distance and the longitudinal distance thereof are acquired by the following approach.

The radial distance of the control point at the midpoint of the radial width of the reverse curve zone to the vertex of the cornea model is d3/2+w1+w2/2. The longitudinal distance of the control point at the midpoint of the radial width of the reverse curve zone to the horizontal plane of the vertex of the cornea model is determined by the peripheral defocusing amount of the reverse curve zone 2.

For the control point selected as any point in the edge of the reverse curve zone, the radial distance and the longitudinal distance thereof are acquired by the following approach.

The radial distance of the control point selected as any point in the edge of the reverse curve zone to the vertex of the cornea model is d3/2+w1+w2. The longitudinal distance of the control point selected as any point in the edge of the reverse curve zone to the horizontal plane of the vertex of the cornea model is determined by a set adaptation degree.

For the control point selected as the midpoint of the radial width of the adaptation curve zone, the radial distance and the longitudinal distance thereof are acquired by the following approach.

The radial distance of the control point at the midpoint of the radial width of the adaptation curve zone to the vertex of the cornea model is d3/2+w1+w2+w3/2.

The control point at the midpoint of the radial width of the adaptation curve zone is set on the cornea model to ensure that the midpoint of the radial width of the adaptation curve zone is in contact with the anterior corneal surface.

For the control point selected as any point in the edge of the adaptation curve zone, the radial distance and the longitudinal distance thereof are acquired by the following approach.

The radial distance of the control point in the edge of the adaptation curve zone to the vertex of the cornea model is d3/2+w1+w2+w3. The longitudinal distance of the control point in the edge of the adaptation curve zone to the horizontal plane of the vertex of the cornea model is determined by the adaptation degree of the adaptation curve zone 3.

For the control point selected as any point in the edge of the peripheral curve zone, the radial distance and the longitudinal distance thereof are acquired by the following approach.

The radial distance of the control point in the edge of the peripheral curve zone to the vertex of the cornea model is d3/2+w1+w2+w3+w4. The longitudinal distance of the control point in the edge of the peripheral curve zone to the horizontal plane of the vertex of the cornea model is determined by the edge warping height of the peripheral curve zone 4.

As can be seen, in addition to calculations of d2 and d3, step S2 further includes selecting the entrance pupil defocusing amount of the base curve zone 1, the peripheral defocusing amount of the reverse curve zone 2, the adaptation degree of the adaptation curve zone 3, and the edge warping height of the peripheral curve zone 4.

In step S3, the orthokeratology lenses model 5 is constructed adaptively on a surface of the cornea model 6 based on the control point data.

In step S3, the constructing the orthokeratology lenses model 5 adaptively on the surface of the cornea model 6 based on the control point data includes the following steps.

Control points are set on the surface of the cornea model 6 according to the control point data.

The curve zones are modeled with the control points to obtain the orthokeratology lenses model 5.

The control points are determined as a closed spline surface of the orthokeratology lenses model. The orthokeratology lenses model is an advanced model based on the modern ophthalmic technology and a computer technique, and can be utilized to customize an exclusive orthokeratology lenses for each patient with accurate corneal morphology data and personalized parameter settings.

As to how the orthokeratology lenses model is constructed with the set control points, a B-spline surface is adopted:

Assuming that there are (m+1)×(n+1) control points p_i,j(i=0, 1, . . . , m; j=0, 1, . . . , n), a mathematical formula of the B-spline surface S(u,v) can be established based on these control points:

$$S ( u , v ) = \sum \sum [ p\_i , j * N\_i , k ( u ) * N\_j , 1 ( v ) ] ;$$

where Σ represents summation; both u and v are parameters; N_i,k(u) and N_j,l(v) are B-spline basis functions based on u and v, respectively, and decide weights of the control points p_i,j; and both k and i are counts of the B-spline surface.

The key of this model is the B-spline basis functions N_i,k(u) and N_j,l(v), which are calculated in a recursive manner:

N_i,0(u)=1 if u_isusu_i+1; otherwise, it is equal to 0.

$$N\_i , k ( u ) = [ ( u - u\_i ) ] / ( u\_i + k - u\_i ) ] \times N\_i , k - 1 ( u ) + [ ( u\_i + k + 1 - u ) / ( u\_i + k + 1 - u\_i + 1 ) ] \times N\_i + 1 , k - 1 ( u ) .$$

N_j,0(v)=1 if v_j≤v≤v_j+1; otherwise, it is equal to 0.

$$N\_j , 1 ( v ) = [ ( v - v\_j ) / ( v\_j + 1 - v\_j ) ] \times N\_j , 1 - 1 ( v ) + [ ( v\_j + 1 + 1 - v ) / ( v\_j + 1 + 1 - v\_j + 1 ) ] \times N\_j + 1 , 1 - 1 ( v ) .$$

These basis functions constitute a complete weight system, and the influence on each control point varies as the parameters u and v vary. The shape of the surface can be changed by adjusting the positions of the control points p_i,j.

It needs to be noted that this model typically needs to be processed by computing software and optimal control points are found to reach an optimal spatial surface. Meanwhile, the optimization of parameters of the closed spline surface of the entire orthokeratology lenses model can be realized in combination with an iterative optimization method such as a gradient descent method or a genetic algorithm.

After step S3, the manufacturing method further includes: the control points of the orthokeratology lenses model are adjusted to meet the customization requirements.

By freely adjusting the control points and changing the spline surface parameters, more customization requirements can be met.

In step S4, orthokeratology lenses for the diseased eye are manufactured in accordance with the orthokeratology lenses model 5.

To sum up, the cornea model is established according to the elevation data of the anterior corneal surface acquired by the corneal topographer. On this basis, the orthokeratology lenses model is integrally formed based on the spline surface. The real orthokeratology lenses are manufactured in accordance with the orthokeratology lenses model. By freely adjusting the control points and changing the spline surface parameters, more customization requirements can be met. The control point is set in the base curve zone such that the functional region of the base curve zone is refined, and the control point is adjusted to provide a controllable entrance pupil defocusing amount for the human eye. The control point is set in the reverse curve zone, and is adjusted to provide a fixed peripheral defocusing amount for corneas having different biological characteristics. The control point is set in the adaptation curve zone, and is adjusted to provide comfortable adaptation degrees for corneas different in morphology. The control point is set in the peripheral curve zone, and is adjusted to design different edge warping heights and provide good oxygen permeability for corneas different in tear film mass. The design method of the orthokeratology lenses based on the spline surface provided in the present disclosure is stable in vision correction, effective for delaying vision progress, and gas permeable and comfortable to wear.

As shown in FIG. 5 and FIG. 6, the present disclosure further provides orthokeratology lenses, which have a base curve zone 1, a reverse curve zone 2, an adaptation curve zone 3, and a peripheral curve zone 4 successively from a center outward.

A center of the base curve zone 1, a midpoint of a radial width of the reverse curve zone 2, a midpoint of a radial width of the adaptation curve zone 3, any point in an outer edge of the base curve zone 1, any point in an outer edge of the reverse curve zone 2, any point in an outer edge of the adaptation curve zone 3, and any point in an outer edge of the peripheral curve zone 4 are set as control points.

The orthokeratology lenses have a rear surface facing the eye and an outward front surface. The front surface and the rear surface of the orthokeratology lenses are consistent in shape, and each have the base curve zone 1, the reverse curve zone 2, the adaptation curve zone 3, and the peripheral curve zone 4, and control points.

A central optical zone 11 is of a structure like a cambered surface in a central region of a lenses body. A near sighting defocusing zone 12 is of a narrow annular structure surrounding the central optical zone 11. The reverse curve zone 2 is of a narrow annular structure surrounding the near sighting defocusing zone 12. The adaptation curve zone 3 is of a widish annular structure surrounding the reverse curve zone 2. The peripheral curve zone 4 is of a narrow annular structure surrounding the adaptation curve zone 3. The axial curvature radius of the base curve zone 1 becomes smaller from inside to outside, and the axial refractive power becomes greater. An axial curvature radius of the central optical zone 11 varies gently from inside to outside, and therefore, there is a small difference in axial refractive power between the center and the edge of the central optical zone 11. An axial curvature radius of the near sighting defocusing zone 12 varies sharply from inside to outside, and therefore, there is a great difference in axial refractive power between the inner and outer edges of the near sighting defocusing zone 12.

Under the compression action of the eyelid, the orthokeratology lenses forces the central region of the anterior corneal surface to remain consistent in shape with the rear surfaces of the inner sides of the central optical zone 11 and the near sighting defocusing zone 12. More entrance pupil defocusing amount is provided while the refractive error of the central region of the cornea is corrected. This is conducive to the delaying and control of vision progress. During the orthokeratology with the lens, a cavity having a certain negative pressure present between the reverse curve zone 2 and the anterior corneal surface forces the epithelial cells of the cornea to be accumulated in the reverse curve zone 2 for forming a peripheral defocusing ring. This further slows down the increase of the degree of myopia while stabilizing the lenses body to a certain extent. In a case where the adaptation curve zone 3 has a high adaptation degree with the anterior corneal surface, the lenses can be fixed at an expected relative position, helping the base curve zone 1 to provide a stable orthokeratology effect. The edge of the peripheral curve zone 4 is slightly warped. The exchange of the tear fluids on the inner and outer sides of the lenses body is smooth and unobstructed.

With reference to FIG. 6, an orthokeratology lenses model 5 is established by a closed spline surface formed by a control point 71 at a center of the central optical zone 11, a control point 72 in an edge of the central optical zone 11, a control point 73 at a midpoint of a radial width of the near sighting defocusing zone 12, a control point 74 in an outer edge of the near sighting defocusing zone 12, a control point 75 at a midpoint of a radial width of the reverse curve zone 2, a control point 76 in an outer edge of the reverse curve zone 2, a control point 77 at a midpoint of a radial width of the adaptation curve zone 3, a control point 78 in an outer edge of the adaptation curve zone 3, and a control point 79 in an outer edge of the peripheral curve zone 4.

The control point 77 at the midpoint of the radial width of the adaptation curve zone 3 is set on a cornea model 6. Therefore, at least one point of a rear surface of the adaptation curve zone 3 of the lenses body is in contact with the anterior corneal surface, thereby guaranteeing that the reverse curve zone 2 can have a relatively enclosed cavity.

By radially adjusting the control point 72 in the edge of the central optical zone 11, the control point 74 in the outer edge of the near sighting defocusing zone 12, the control point 76 in the outer edge of the reverse curve zone 2, and the control point 78 in the outer edge of the adaptation curve zone 3, orthokeratology lenses models 5 having different diameters of the central optical zone 11, and different radial widths of the near sighting defocusing zone 12, the reverse curve zone 2, the adaptation curve zone 3, and the peripheral curve zone 4 are designed for corneas having different iris diameters and pupil diameters. By longitudinally adjusting the control point 71 at the center of the central optical zone 11, a sufficient tear film thickness is reserved between the center of the rear surface of the lenses and the vertex of the cornea to guarantee the safety of the orthokeratology. Accordingly, the control point 72 in the edge of the central optical zone 11 may also displace correspondingly in the longitudinal direction to guarantee that the axial curvature radius of the central optical zone 11 does not vary. By longitudinally adjusting the control point 72 in the edge of the central optical zone 11, the axial curvature radius of the central optical zone 11 is changed such that the axial curvature radius of the center of the central optical zone 11 is equal to an axial curvature radius calculated from a diopter measured by an auto-refractor and a corneal curvature acquired by a corneal topographer, and a difference between an axial refractive power of the edge of the central optical zone 11 and an axial refractive power of the center of the central optical zone 11 is greater than or equal to 0 D and less than or equal to 0.5 D, thereby guaranteeing that the center of the lenses has a good diopter correction effect on the center of the cornea.

By longitudinally adjusting the control point 73 at the midpoint of the radial width of the near sighting defocusing zone 12, the axial curvature radius of the near sighting defocusing zone 12 is changed so that an axial diopter variation of the near sighting defocusing zone 12 can provide an expected entrance pupil defocusing amount.

By longitudinally adjusting the control point 75 at the midpoint of the radial width of the reverse curve zone 2, the axial curvature radius of the reverse curve zone 2 is changed to reserve different cavity volumes of the reverse curve zone 2 for corneas having different biological characteristics so as to reach an expected peripheral defocusing amount. By longitudinally adjusting the control point 76 in the outer edge of the reverse curve zone 2 and the control point 78 in the outer edge of the adaptation curve zone 3, the axial curvature radius of the adaptation curve zone 3 is changed to change a contact area of the adaptation curve zone 3 with the anterior corneal surface so as to reach an expected adaptation degree.

By longitudinally adjusting the control point 79 in the outer edge of the peripheral curve zone 4, a longitudinal height difference between the outer edge of the peripheral curve zone 4 and the anterior corneal surface is equal to an expected edge warping height.

In conclusion, by freely adjusting the control points and changing the spline surface parameters, more customization requirements can be met. The control point is set in the base curve zone such that the functional region of the base curve zone is refined, and the control point is adjusted to provide a controllable entrance pupil defocusing amount for the human eye. The control point is set in the reverse curve zone, and is adjusted to provide a fixed peripheral defocusing amount for corneas having different biological characteristics. The control point is set in the adaptation curve zone, and is adjusted to provide comfortable adaptation degrees for corneas different in morphology. The control point is set in the peripheral curve zone, and is adjusted to design different edge warping heights and provide good oxygen permeability for corneas different in tear film mass.

The above embodiments are only used to illustrate the technical ideas and features of the present disclosure, such that those skilled in the art can understand the content of the present disclosure and implement the present disclosure accordingly. The scope of the present disclosure is not limited by the above embodiments, that is, any equivalent changes or modifications made to the spirit disclosed by the present disclosure still fall within the scope of the present disclosure.

What is claimed is:

1. A manufacturing method of orthokeratology lenses, comprising:
acquiring parameters of diseased eyes;
constructing a cornea model (6) based on the parameters of the diseased eyes, and obtaining control point data of an orthokeratology lenses model (5) according to the parameters of the diseased eyes and the cornea model (6);
constructing the orthokeratology lenses model (5) adaptively on a surface of the cornea model (6) based on the control point data; and
manufacturing orthokeratology lenses for the diseased eyes in accordance with the orthokeratology lenses model (5).

2. The manufacturing method according to claim 1, wherein the parameters of the diseased eyes comprise elevation data of the anterior corneal surface; and the constructing the cornea model (6) based on the parameters of the diseased eyes comprises:
fitting the elevation data of the anterior corneal surface to obtain the cornea model (6).

3. The manufacturing method according to claim 1, wherein the obtaining the control point data of the orthokeratology lenses model (5) according to the parameters of the diseased eyes and the cornea model (6) comprises:
obtaining dimensions data of curve zones of the orthokeratology lenses model (5) according to the parameters of the diseased eyes, wherein the curve zones of the orthokeratology lenses model (5) comprises a base curve zone (1), a reverse curve zone (2), an adaptation curve zone (3), and a peripheral curve zone (4) successively from a center outward in a radial direction of the orthokeratology lenses model; and
selecting control points of the curve zones of the orthokeratology lenses model (5), and obtaining the control point data of the orthokeratology lenses model (5) according to the dimensions data of the curve zones of the orthokeratology lenses model (5).

4. The manufacturing method according to claim 3, wherein the obtaining the dimensions data of the curve zones of the orthokeratology lenses model (5) according to the parameters of the diseased eyes comprises:
determining radial dimensions of the base curve zone (1), the reverse curve zone (2), the adaptation curve zone (3), and the peripheral curve zone (4) according to the parameters of the diseased eyes; and
selecting an entrance pupil defocusing amount of the base curve zone (1), a peripheral defocusing amount of the reverse curve zone (2), an adaptation degree of the adaptation curve zone (3), and an edge warping height of the peripheral curve zone (4).

5. The manufacturing method according to claim 4, wherein the parameters of the diseased eyes comprise a horizontal iris diameter; and the determining the radial dimensions of the base curve zone (1), the reverse curve zone (2), the adaptation curve zone (3), and the peripheral curve zone (4) according to the parameters of the diseased eyes comprises:
calculating a diameter of the orthokeratology lenses model (5) according to the horizontal iris diameter; and
determining the radial dimensions of the base curve zone (1), the reverse curve zone (2), the adaptation curve zone (3), and the peripheral curve zone (4) based on the diameter of the orthokeratology lenses model (5).

6. The manufacturing method according to claim 3, wherein the selecting the control points of the curve zones of the orthokeratology lenses model (5) comprises:
selecting a center of the base curve zone (1), a midpoint of a radial width of the reverse curve zone (2), a midpoint of a radial width of the adaptation curve zone (3), any point in an outer edge of the base curve zone (1), any point in an outer edge of the reverse curve zone (2), any point in an outer edge of the adaptation curve zone (3), and any point in an outer edge of the peripheral curve zone (4) as the control points.

7. The manufacturing method according to claim 3, wherein the control point data comprises a radial distance and a longitudinal distance; and the obtaining the control point data of the orthokeratology lenses model (5) according to the dimensions data of the curve zones of the orthokeratology lenses model (5) comprises:
obtaining radial distances of the control points of the curve zones according to the radial dimensions of the base curve zone (1), the reverse curve zone (2), the adaptation curve zone (3), and the peripheral curve zone (4); and
calculating longitudinal distances of the control points of the curve zones based on the entrance pupil defocusing amount of the base curve zone (1), the peripheral defocusing amount of the reverse curve zone (2), the adaptation degree of the adaptation curve zone (3), and the edge warping height of the peripheral curve zone (4).

8. The manufacturing method according to claim 1, wherein the constructing the orthokeratology lenses model (5) adaptively on the surface of the cornea model (6) based on the control point data comprises:
setting control points on the surface of the cornea model (6) according to the control point data; and
modeling the curve zones with the control points to obtain the orthokeratology lenses model (5).

9. Orthokeratology lenses, having a base curve zone (1), a reverse curve zone (2), an adaptation curve zone (3), and a peripheral curve zone (4) successively from a center outward,
wherein a center of the base curve zone (1), a midpoint of a radial width of the reverse curve zone (2), a midpoint of a radial width of the adaptation curve zone (3), any point in an outer edge of the base curve zone (1), any point in an outer edge of the reverse curve zone (2), any point in an outer edge of the adaptation curve zone (3), and any point in an outer edge of the peripheral curve zone (4) are set as control points.
